(19) United States
(12) Patent Application Publication
(10) Pub. No.: US 2008/0183436 A1
(43) Pub. Date: Jul. 31, 2008

(54) Method of evolutionary optimization algorithm for structure design

(75) Inventors: Yu-Ming Chen, Taoyuan County (TW); Chun-I Chu, Hsinchu County (TW); Ya-Ping Lee, Miaoli County (TW); Tze-Chin Chou, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 12/000,069

(22) Filed: Dec. 7, 2007

(30) Foreign Application Priority Data
Jan. 30, 2007 (TW) 096103280

(51) Int. Cl. G06F 17/50

(52) U.S. Cl. 703/1

(57) ABSTRACT

The present invention discloses a method of evolutionary optimization algorithm for structure design which comprises steps of: meshing a geometric structure with applied geometric boundary conditions; analyzing the meshed geometric structure by finite element analysis to determine the relative stress distribution of the structure; and evolving the geometric structure by migrating geometric boundary nodes. During evolution, meshing and finite element analysis are repeated to perform structural optimization evolutionally till the evolving design converged to an optimum. The present invention overcomes the mesh-dependency problem in most of structural optimization algorithms in the field of structure topology optimization. In addition, the optimized design of the present invention possesses smooth geometric boundaries. Moreover, structure topology resolutions can be controlled and capable of producing designs that are very close to exact theoretical analysis.

### BACKGROUND OF THE INVENTION

1. Field of the Invention:

The present invention generally relates to a method of evolutionary optimization algorithm for structure design and, more particularly, to a method of evolutionary optimization algorithm for structure design by moving boundary nodes with lower stress towards a design domain with higher stress to achieve structure optimization.

2. Description of the Prior Art:

The development of optimization for structure design has been a topic of interests for over one hundred years. The origin is roughly the same time when finite element analysis (FEA) was formulated. After years of experience and development, structure designers can easily come up with a design that fulfills the structural requirements and provides a safe and stable framework to withstand external disturbances.

However, in addition to the essential structural requirements, structure designers do not only come up with a design that satisfies the geometric boundary loading and forcing conditions, but also provide a relatively optimum design in terms of efficiently used materials. Thereby, the manufacturing and material costs can be reduced so that the product is less costly and more competitive in the market. This directly reflects the importance of structure optimization.

To date, there are a few optimization methods and algorithms that have been developed but only few are linked to finite element analysis. Most of the existing structural optimization algorithms require professional experiences, which has been addressed as one of the reasons that structural optimization attracts less attention than finite element analysis.

An exemplifying prior art disclosure using topology optimization with finite element analysis will be described hereinafter. A well-known benchmark problem in the field of topology optimization is the Michell's Arc problem. Please refer to FIG. 1A, which is a schematic diagram of a meshed geometric structure. First, a geometric structure 90 is meshed. The geometric structure 90 is usually rectangular. Boundary and loading conditions are applied before finite element analysis is performed on the geometric structure 90. According to the stress distribution for the geometric structure 90 resulting from FEA, meshes 901 with relatively lower stress are removed. Finally, iteration is used to achieve structure evolution.

However, the aforementioned optimization algorithm has disadvantages such as:

(1) Mesh Dependency: The geometric structure is meshed and the meshes 901 with relatively lower stress are removed. Therefore, structure optimization depends on the resolution, distribution and shape of the meshes. Please refer to FIG. 1B and FIG. 1B, which are schematic diagrams of meshes in FIG. 1A. In FIG. 1B, there are 4 triangular meshes 902 in a rectangular mesh group. In FIG. 1C, there are 8 triangular meshes 903 in a rectangular mesh group. The mesh resolutions and mesh orientations in FIG. 1B and FIG. 1C are different. After structure optimization, the topology resolutions in FIG. 1B and FIG. 1C will be different. The results will not be the same under the same iteration condition. FIG. 2A shows the structure as a result of structure optimization corresponding to FIG. 1B and FIG. 2B shows the structure as a result of structure optimization corresponding to FIG. 1C. It is found from FIG. 2A and FIG. 2B that the obtained structure depends strongly on the mesh resolution.

(2) Stair-Case Effect: When the meshes are removed, a sawtooth shaped edge appears on the meshed structure. In other words, the boundary of the optimized structure is not smooth, which causes distortion.

(3) Comparing FIG. 2A or FIG. 2B with FIG. 3, which is a theoretical solution to the Michell's Arc problem, the conventional structure optimization algorithm (FIG. 2A or FIG. 2B) is far from satisfactory.

Therefore, there is need in providing a method of evolutionary optimization algorithm for structure design to overcome the aforementioned problems in the prior art.

### SUMMARY OF THE INVENTION

It is one object of the present invention to provide a method of evolutionary optimization algorithm for structure design, using a polygon to describe a geometric structure and performing finite element analysis to move the evolutionary nodes to optimize the structure and achieve structural optimization.

It is another object of the present invention to provide a method of evolutionary optimization algorithm for structure design, wherein the structure is changed by moving the nodes to overcome the mesh-dependency problem in the prior art.

It is still another object of the present invention to provide a method of evolutionary optimization algorithm for structure design, wherein the structure is changed by moving the nodes overcome the stair-case effect to achieve smooth geometric boundaries.

In order to achieve the foregoing objects, the present invention provides a method of evolutionary optimization algorithm for structure design, comprising steps of: (a) creating a design domain with at least one boundary condition; (b) meshing the design domain for performing finite element analysis (FEA) to determine a stress distribution corresponding to the design domain; (c) moving at least one node on the boundary of the design domain according to the stress distribution to create a new design domain; and (d) repeating from step (b) to step (d) according to the new design domain as a result of step (c) to create a structure.

In order to achieve the foregoing objects, the present invention further provides a method of evolutionary optimization algorithm for structure design, comprising steps of: (a) creating a design domain with at least one boundary condition; (b) meshing the design domain for performing finite element analysis (FEA) to determine a stress distribution corresponding to the design domain; (c) creating at least one cavity in the design domain; (d) moving at least one node on the boundary of the design domain and at least one node on the boundary of the cavity according to the stress distribution to create a new design domain; and (e) repeating from step (b) to step (e) according to the new design domain as a result of step (d) to create a structure.

### BRIEF DESCRIPTION OF THE DRAWINGS

The objects, spirits and advantages of the preferred embodiment of the present invention will be readily understood by the accompanying drawings and detailed descriptions, wherein:

FIG. 1A is a schematic diagram of a meshed geometric structure;

FIG. 1B and FIG. 1C are schematic diagrams of meshes;

FIG. 2A shows the structure as a result of structure optimization corresponding to FIG. 1B;

FIG. 2B shows the structure as a result of structure optimization corresponding to FIG. 1C;

FIG. 3 is a schematic diagram of a theoretical solution to the Michell's Arc problem;

FIG. 4A is a flow-chart of a method of evolutionary optimization algorithm for structure design according to a first embodiment of the present invention;

FIG. 4B is a schematic diagram of a design domain according to a first embodiment of the present invention;

FIG. 5A is a flow-chart of a step of moving a boundary node according to a first embodiment of the present invention;

FIG. 5B is a flow-chart of a step of determining the movement direction and the movement magnitude of a boundary node according to a first embodiment of the present invention;

FIG. 5C is a schematic diagram showing a boundary node according to a first embodiment of the present invention;

FIG. 5D is a schematic diagram showing a plurality of meshes for determining the movement magnitude of boundary node according to a first embodiment of the present invention;

FIG. 5E is a schematic diagram showing the angle between two datum axes according to the present invention;

FIG. 6 is a schematic diagram showing a bridge structure;

FIG. 7 is a flow-chart of a method of evolutionary optimization algorithm for structure design according to a second embodiment of the present invention;

FIG. 8A is a flow-chart of a step of forming a cavity according to a second embodiment of the present invention;

FIG. 8B is a flow-chart of a step of removing an ineffective node in a design domain according to a second embodiment of the present invention;

FIG. 8C is a flow-chart of a step of removing an ineffective node in an ineffective domain according to a second embodiment of the present invention;

FIG. 8D is a flow-chart of an alternative step of forming a cavity according to a second embodiment of the present invention;

FIG. 9A and FIG. 9B are schematic diagrams showing a first specific displacement and a second specific displacement according to a second embodiment of the present invention;

FIG. 10A is a flow-chart of a step of moving a boundary node according to a second embodiment of the present invention;

FIG. 10B and FIG. 10C show a flow-chart of a step of determining the movement direction and the movement magnitude of a boundary node according to a second embodiment of the present invention;

FIG. 11A is a flow-chart of a step of combining two cavities;

FIG. 11B is shows schematic diagrams of a step of combining two cavities;

FIG. 12A shows schematic diagrams of a solution to the Michell's Arc problem using a method of evolutionary optimization algorithm for structure design according to a second embodiment of the present invention; and

FIG. 12B shows schematic diagrams of a solution to a cantilever truss problem using a method of evolutionary optimization algorithm for structure design according to a second embodiment of the present invention.

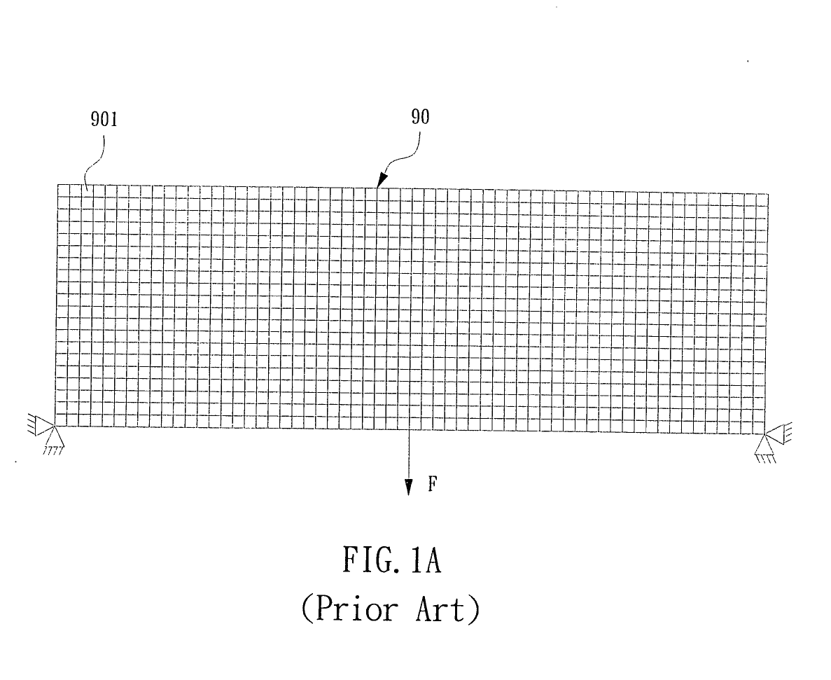

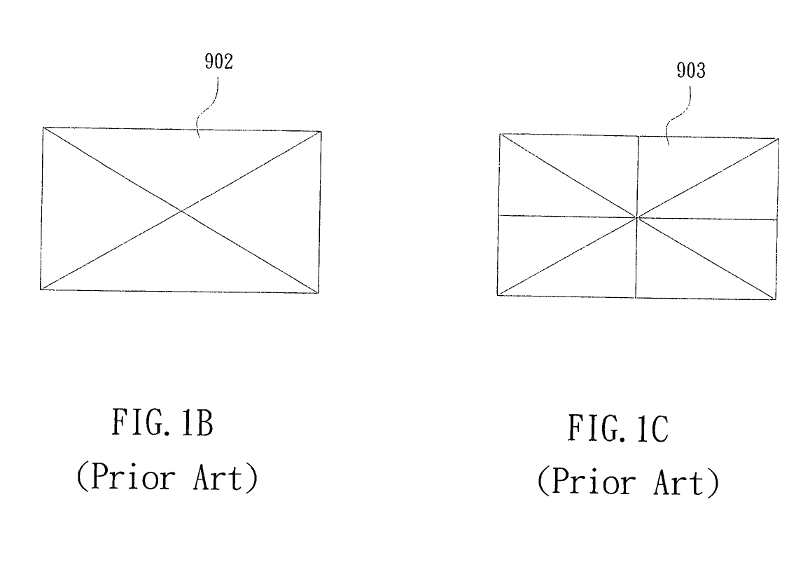

### DETAILED DESCRIPTION OF THE PREFERRED EMBODIMENT

The present invention providing a method of evolutionary optimization algorithm for structure design can be exemplified by the preferred embodiment as described hereinafter.

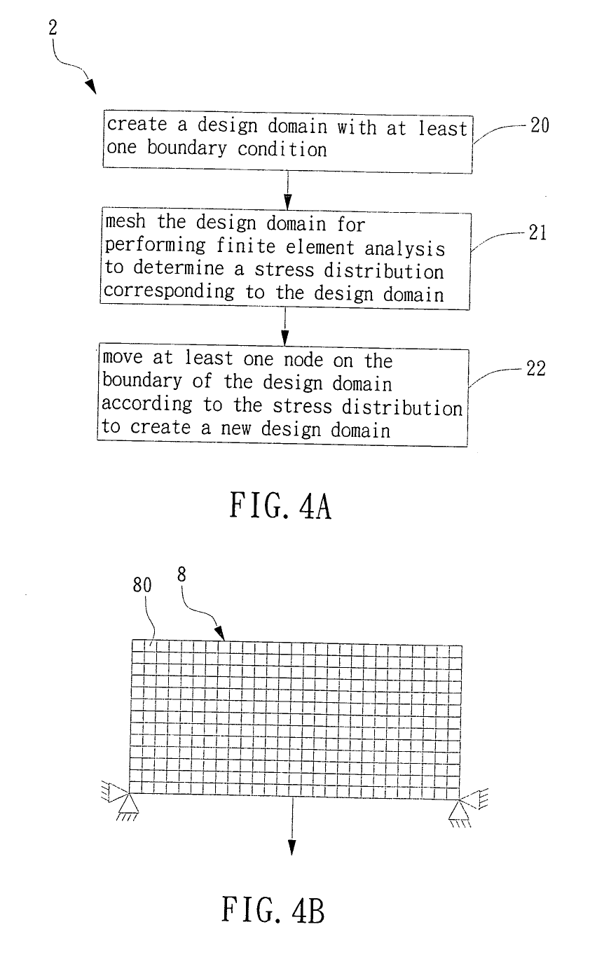

Please refer to FIG. 4A, which is a flow-chart of a method of evolutionary optimization algorithm for structure design according to a first embodiment of the present invention. One object of the present invention is to achieve structure optimization of a design domain by moving the nodes on the boundary of the design domain. The method 2 starts with Step 20, wherein a design domain is created with at least one boundary condition. The design domain is arbitrarily shaped, generally rectangular, as shown in FIG. 4B. Alternatively, the design domain is a planar domain, a 3-D domain or an initially shaped structure. The initially shaped structure is a pre-designed structure, which is then to be optimized. Prior to being optimized, the design domain is arbitrarily shaped, which means that a boundary condition is given without determining the shape thereof. The design domain is re-shaped to achieve structure optimization using the method of the present invention. The boundary condition is given based on the requirement of structure design.

Then, in Step 21, the design domain is meshed for performing finite element analysis (FEA) to determine a stress distribution corresponding to the design domain. In FIG. 4B, there are a plurality of meshes 80 in the design domain 8. The meshes 80 can be triangular, rectangular, polygonal or arbitrarily shaped. The meshes 80 can be generated using a mesh generator, which is a stress analysis software application. After the meshes are generated, finite element analysis is performed to determine a stress distribution corresponding to the design domain.

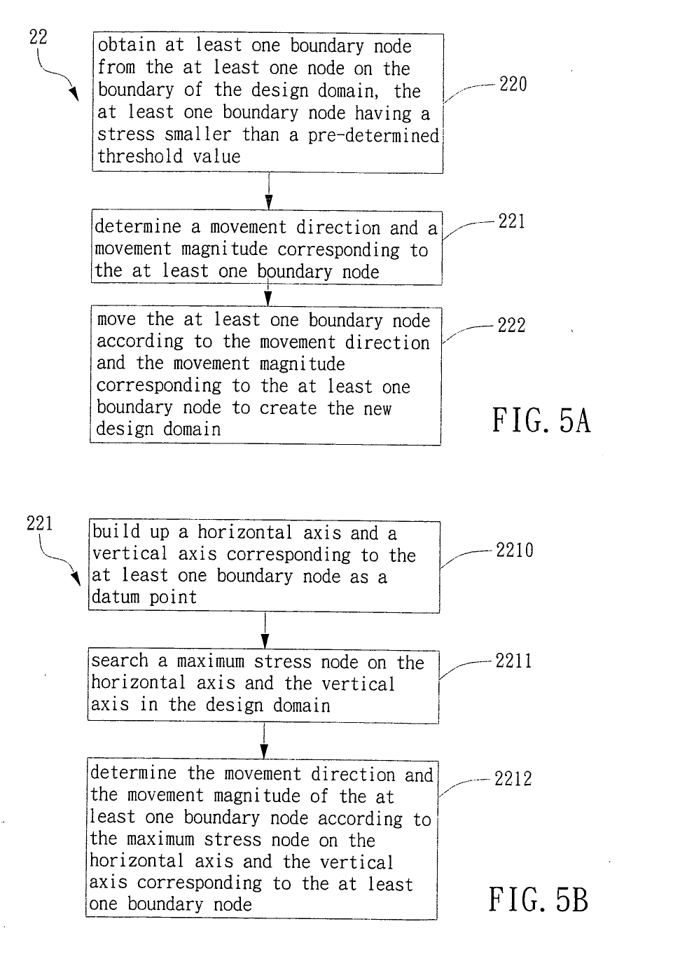

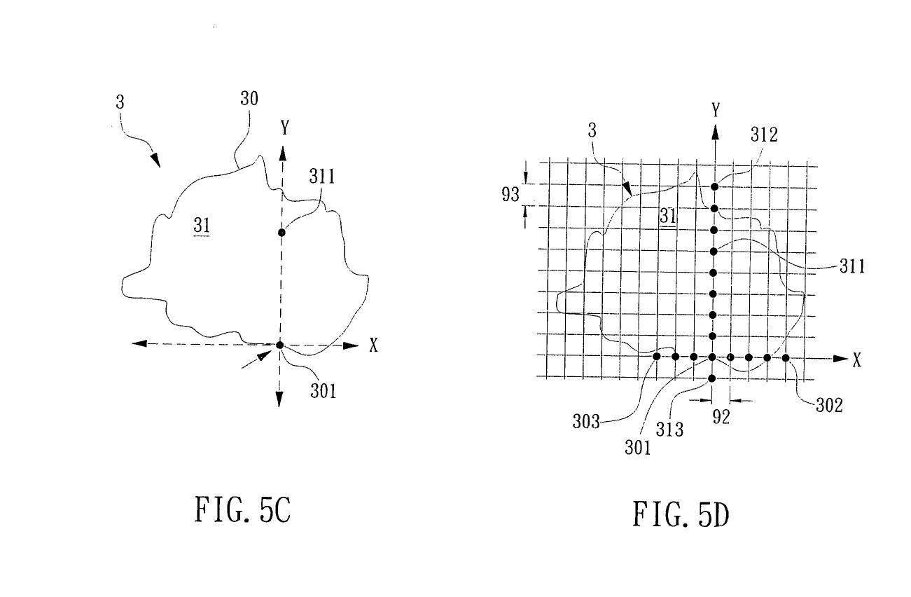

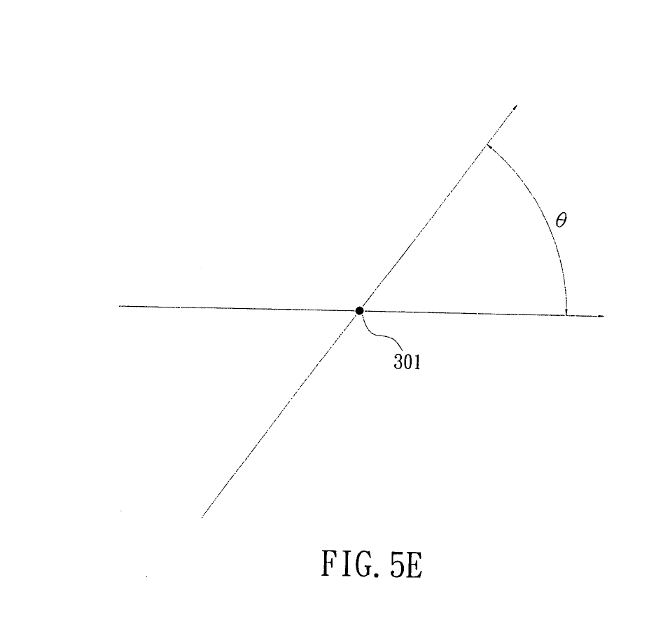

Returning to FIG. 4A, in Step 22, at least one node on the boundary of the design domain is moved according to the stress distribution to create a new design domain. For more details, please refer to FIG. 5A, which is a flow-chart of a step of moving a boundary node according to a first embodiment of the present invention. First, in Step 220, at least one boundary node is obtained from the at least one node on the boundary of the design domain, wherein the at least one boundary node have a stress smaller than a pre-determined threshold value. In Step 21, after finite element analysis (FEA), a stress can be found in the design domain as the pre-determined threshold value for obtaining the at least one boundary node. In the present embodiment, the pre-determined threshold value is the product of a Maximum Von Mises stress in the design domain using FEA and an optimum ratio (OR), ORσ_{N}^{VM max}. The stress values corresponding to the nodes on the boundary of the design domain are compared with the pre-determined threshold value to determine a least one boundary node having a stress smaller than a pre-determined threshold value.

In step 221, a movement direction and a movement magnitude are determined corresponding to the at least one boundary node. Please refer to FIG. 5B, which is a flow-chart of a step of determining the movement direction and the movement magnitude of a boundary node according to a first embodiment of the present invention. The step of determining the movement direction and the movement magnitude comprises two steps. In Step 2210, two datum axes are built up corresponding to the at least one boundary node as a datum point. In the present embodiment, the two datum axes are a horizontal axis and a vertical axis. Then in Step 2211, a maximum stress node on the horizontal axis and the vertical axis, respectively, in the design domain is searched. In Step 2212, the movement direction and the movement magnitude of the at least one boundary node are determined according to the maximum stress node on the horizontal axis and the vertical axis corresponding to the at least one boundary node. The movement direction and the movement magnitude are functions of a relative distance and a relative stress. The relative distance indicates a distance from the boundary node to the maximum stress node, and the relative stress indicates a ratio of the stress on the boundary node to the stress on the maximum stress node.

Please refer to FIG. 5C and FIG. 5D, wherein FIG. 5C is a schematic diagram showing a boundary node according to a first embodiment of the present invention and FIG. 5D is a schematic diagram showing a plurality of meshes for determining the movement magnitude of boundary node according to a first embodiment of the present invention. FIG. 5C and FIG. 5D are used here to further describe the flow-chart in FIG. 5B. In FIG. 5C, there are a plurality of boundary nodes (exemplified by a boundary node 301) on the boundary 30 of the design domain 3. These boundary nodes are selected in Step 20. Taking the boundary node 301 for example, the boundary node 301 is used as an origin to build up a horizontal axis X and a vertical axis Y to define the size of a mesh as shown in FIG. 5D. In FIG. 5D, steps 92 and 93 represent the distance along the X-direction and the distance along the Y-direction, respectively, to determine the positions of the nodes. The maximum stress node is then searched. In Table 1, the boundary node 301 is used as the origin and the stress for all the nodes on the X axis is shown.

From Table 1, with the boundary node 301 as the origin, the boundary node 301 among all the nodes on the X-axis in the design domain 31 has the largest stress, 100 MPa. In Table 1, NaN indicates “not a number”, which means the corresponding node is not inside the design domain, for example nodes 302 and 303 in FIG. 5D.

TABLE 1

| | Stress (Mpa) | | | | | | | |
|---|---|---|---|---|---|---|---|---|
| | NaN | 90 | 96 | 100 | 73 | 66 | 55 | NaN |
| Distance | −3 | −2 | −1 | 0 | 1 | 2 | 3 | 4 |
| from the | | | | | | | | |
| boundary | | | | | | | | |
| node along | | | | | | | | |
| X-axis | | | | | | | | |

The way for searching the maximum stress node on the Y-axis is similar to that for searching the maximum stress node on the X-axis. In Table 2, with the boundary node 301 as the origin, the node 311 among all the nodes on the Y-axis in the design domain 31 has the largest stress, 225 MPa. The node 311 is 5 steps 93 away from boundary node 301. In Table 2, NaN indicates “not a number”, which means the corresponding node is not inside the design domain, for example nodes 312 and 313 in FIG. 5D.

TABLE 2

| | Stress (MPa) | | | | | | | | | |
|---|---|---|---|---|---|---|---|---|---|---|
| | NaN | 100 | 148 | 157 | 168 | 179 | 225 | 182 | 188 | NaN |
| Distance | −1 | 0 | 1 | 2 | 3 | 4 | 5 | 6 | 7 | 8 |
| from the | | | | | | | | | | |
| boundary node | | | | | | | | | | |
| along Y-axis | | | | | | | | | | |

After the maximum stress node corresponding to the boundary node 301 is found, the movement direction and the movement magnitude can be determined in Step 2112. The movement direction and the movement magnitude can be expressed as:

$$\begin{matrix}{X}_{i} = {X}_{i} + ( sgn ( {P}_{x\_ref} ) ( 1 - \frac{1}{\vert {P}_{x\_ref} \vert} ) [ 1 - \frac{{σ}_{i}}{{σ}_{x\_ref}} ] \} {X}_{d} , & ( 1 ) \\ {Y}_{i} = {Y}_{i} + \{ sgn ( {P}_{y\_ref} ) ( 1 - \frac{1}{\vert {P}_{y\_ref} \vert} ) [ 1 - \frac{{σ}_{i}}{{σ}_{y\_ref}} ] \} {Y}_{d} . & ( 2 )\end{matrix}$$

wherein Xᵢ, Yᵢ on the right side represent the current position of the boundary node and Xᵢ, Yᵢ on the left side represent the new position of the boundary node; Pₓ_{_{—}}_{ref}, P_{y}_{_{—}}_{ref} represent the relative distance between the boundary node and the maximum stress node along the X-axis and the Y-axis, respectively. Taking the boundary node 301 for example, Pₓ_{_{—}}_{ref}=0 and P_{y}_{_{—}}_{ref}=5. The sgn function is used to decide the direction of each nodal movement with respect to the local nodal position, positive indicating the movement direction being right or up and negative indicating the movement direction being left or bottom. Moreover, σᵢ indicates the stress on the boundary node. Taking the boundary node 301 for example, σᵢ=100 Mpa. σₓ_{_{—}}_{ref}, σ_{y}_{_{—}}_{ref} represent the maximum stress on the X-axis and the Y-axis, respectively. For example, σₓ_{_{—}}_{ref}=100 MPa and (σ_{y}_{_{—}}_{ref}=225 MPa. X_{d}, Y_{d} represent the proportional functions, which are pre-determined. The proportional functions indicate the movement resolution, which relates to the computation speed and is determined according to actual requirements. Accordingly, the movement direction and the movement magnitude can be determined using equations (1) and (2).

Please refer to FIG. 5E, which is a schematic diagram showing the angle between two datum axes according to the present invention. In addition to the horizontal axis and the vertical axis as previously described, the angle between two datum axes can vary within a range from 0 degree to 90 degrees. In this case, coordinate transformation is required to obtain the movement direction and the movement magnitude. Therefore, the two datum axes are not limited to the horizontal axis and the vertical axis. Moreover, when Pₓ_{_{—}}_{ref} or P_{y}_{_{—}}_{ref} is zero, the reciprocal of the absolute value of Pₓ_{_{—}}_{ref} or P_{y}_{_{—}}_{ref} in equation (1) or (2) tends to infinity. However, (1−σᵢ/σₓ_{_{—}}_{ref}) or (1−σᵢ/σ_{y}_{_{—}}_{ref}) equals to zero because σᵢ=σₓ_{_{—}}_{ref} or σᵢ=σ_{y}_{_{—}}_{ref} when Pₓ_{_{—}}_{ref} or P_{y}_{_{—}}_{ref} is zero. In other words, the product term in equation (1) or (2) is zero. Therefore, when Pₓ_{_{—}}_{ref} or P_{y}_{_{—}}_{ref} is zero, the total contribution to the nodal displacement is zero and hence the boundary node does not need to be moved.

After the movement direction and the movement magnitude are determined, return to FIG. 5A for Step 222. In Step 222, the at least one boundary node is moved according to the movement direction and the movement magnitude corresponding to the at least one boundary node to create the new design domain. As shown in FIG. 5C, after the calculation corresponding to the boundary node 301 is completed, the steps in FIG. 5A and FIG. 5B are performed on other boundary nodes obtained in Step 220. When all the boundary nodes are moved, the design domain 3 is re-shaped. Repeating the steps in FIG. 4A, the original design domain is evolved to a new structure to achieve structure optimization.

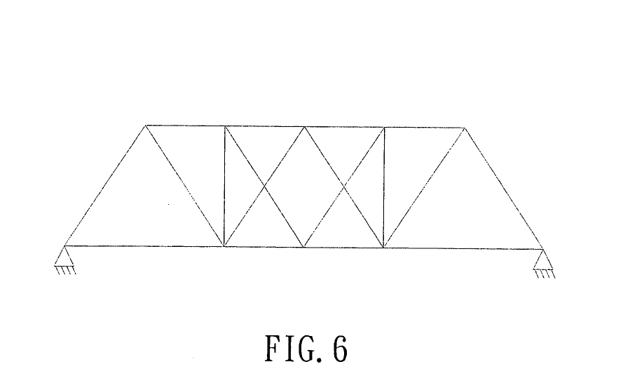

In FIG. 4A, the boundary nodes on the boundary of the design domain are moved so as to achieve structure optimization for an arbitrarily shaped design domain. However, in some cases, as shown in FIG. 6, which is a schematic diagram showing a bridge structure, the bridge structure is a trapezoid with a plurality of rigid frames interconnected. Such a structure can be seen as a power tower or a framework of an aerofoil, which is hollow inside. The hollow structure is advantageous in reduced material cost. Structure optimization for such a structure requires topology algorithm in addition to the evolutional structural optimization as previously described.

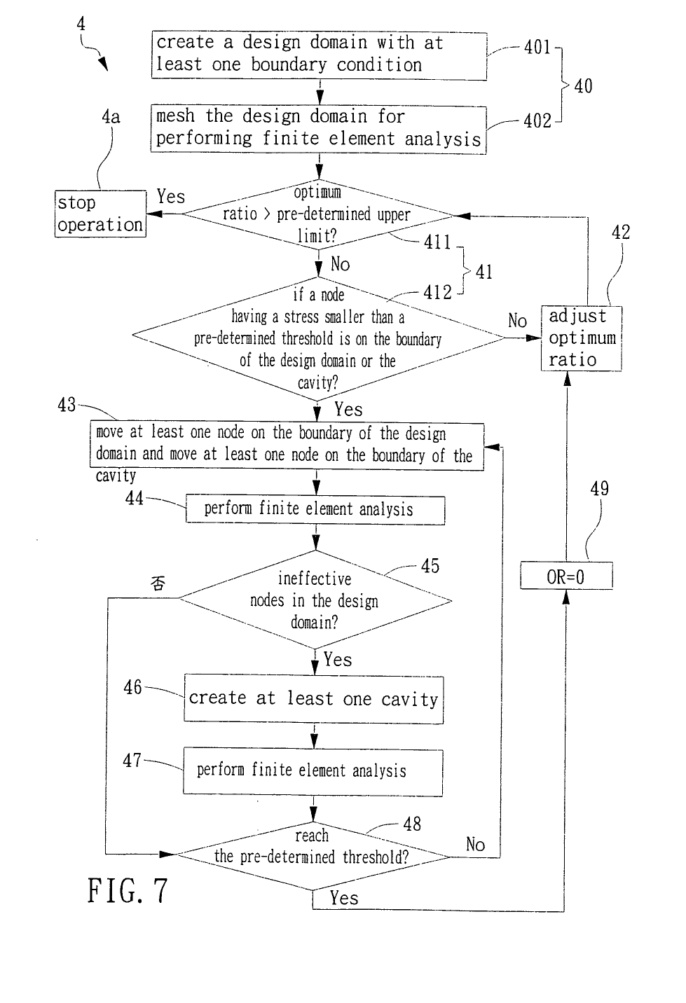

Please refer to FIG. 7, which is a flow-chart of a method of evolutionary optimization algorithm for structure design according to a second embodiment of the present invention. The method comprises two major parts. The first part of this method is to reform the design domain and the second part is to create cavities inside the design domain and then to move the boundary of the cavities according to the result of the first part.

The method 4 comprises steps described hereinafter. First, in Step 40, a design domain is analyzed. More particularly, in Step 401, a design domain is created with at least one boundary condition. In step 402, the design domain is meshed for performing finite element analysis (FEA). The design domain is arbitrarily shaped, generally rectangular. Alternatively, the design domain is a planar domain, a 3-D domain or an initially shaped structure.

Then in Step 41, a stress distribution corresponding to the design domain is determined. More particularly, in Step 411, it is determined whether an optimum ratio (OR) is larger than a pre-determined upper limit. In the present embodiment, if OR equals to 1, the method goes to Step 4a to stop operation. Otherwise, the method goes to Step 412 to determine whether a node having a stress smaller than a pre-determined threshold is on the boundary of the design domain if OR is smaller than 1. The pre-determined threshold value is the product of a Maximum Von Mises stress in the design domain using FEA and an optimum ratio (OR), ORσ_{N}^{VM max}. It is determined whether there is any node, on the design domain boundary, with a stress smaller than the pre-determined threshold value. If there is no such node, the method goes to Step 42 to adjust the optimum ratio, i.e., OR=OR+δOR, to find a new OR, which is re-determined in Step 41 until a node having a stress smaller than a pre-determined threshold is found on the boundary of the design domain. Meanwhile, the cavity part of Step 412 is skipped because there is no cavity so far.

If there is any node having a stress smaller than a pre-determined threshold is found on the boundary of the design domain, the method goes to Step 43 to move at least one node on the boundary of the design domain. The way of moving is similar to that in the first embodiment and thus the description thereof is not repeated. Meanwhile, the cavity part of Step 43 is skipped because there is no cavity in the design domain so far. After the boundary node is moved, the method goes to Step 44 to perform finite element analysis on the re-shaped design domain. Then in Step 45, according to stress analysis, it is determined whether there is node, in the design domain, having a stress smaller than any boundary node having a minimum stress in the design domain, i.e., the ineffective node. The method goes to Step 46 to create at least one cavity in the design domain if there is any ineffective node.

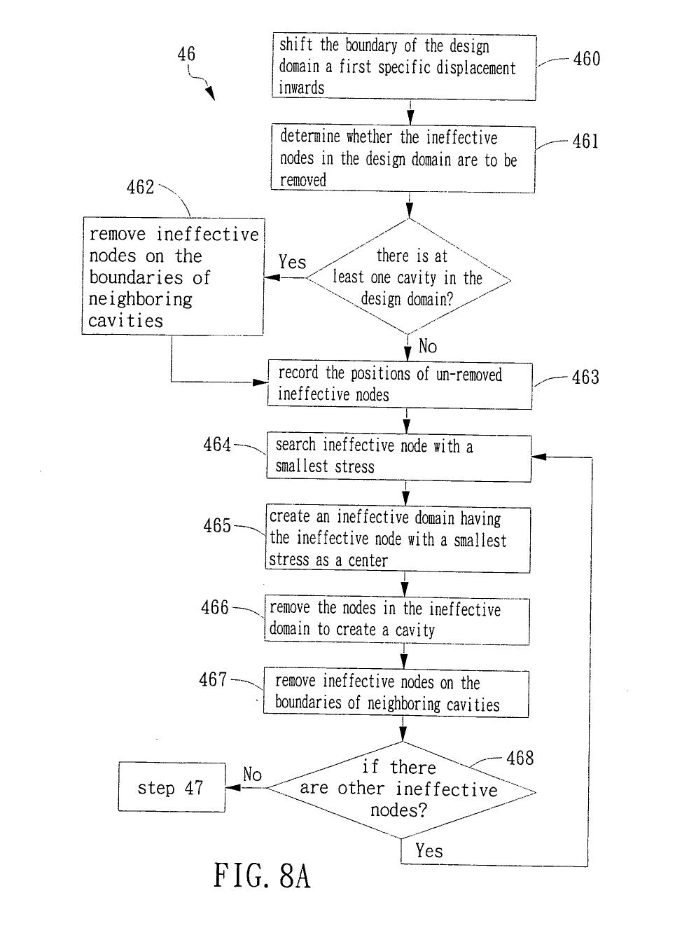

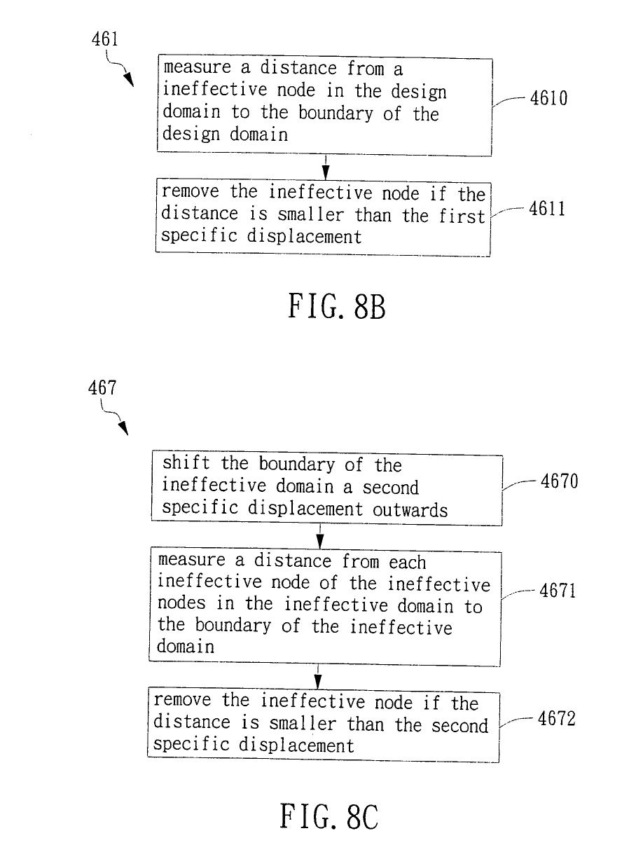

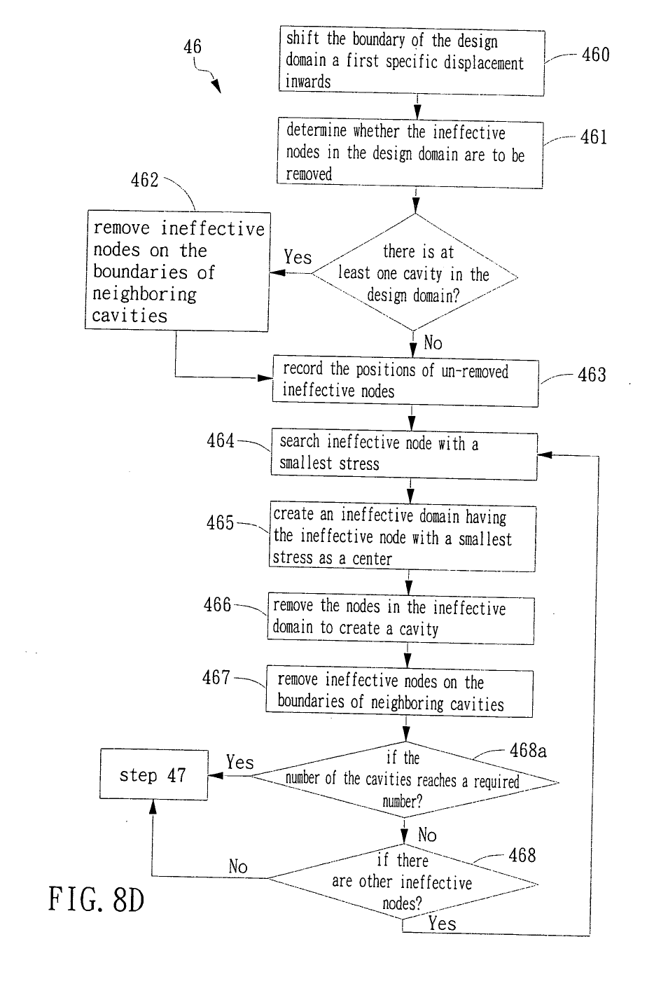

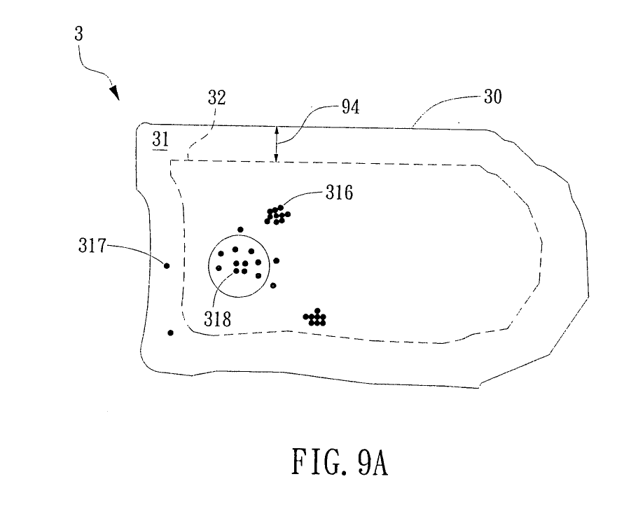

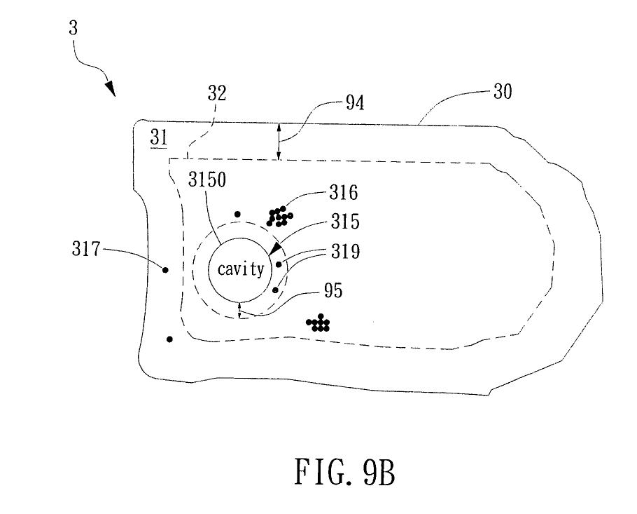

Please refer to FIG. 8A, which is a flow-chart of a step of forming a cavity according to a second embodiment of the present invention. In order to create a cavity, in Step 460, the boundary of the design domain is shifted a first specific displacement 94 inwards, as shown in FIG. 9A. Then in Step 461, it is determined whether the ineffective nodes in the design domain are to be removed. As shown in FIG. 8B, Step 460 comprises Step 4610 and Step 4611. In Step 4610, a distance from an ineffective node in the design domain to the boundary of the design domain is measured. In Step 4611, the ineffective node is removed if the distance is smaller than the first specific displacement 94. With reference to FIG. 9A, nodes 316 and 317 are ineffective nodes. The node 316 does not need to be removed because the distance from the node 316 to the design domain boundary 30 is larger than the first specific displacement 94. However, the node 317 needs to be removed because the distance from the node 317 to the design domain boundary 30 is smaller than the first specific displacement 94.

The method returns to FIG. 8A to determine whether there is any cavity in the design domain after the ineffective nodes near the design domain 30 are removed. If there is a cavity in the design domain, the method goes to Step 462 to remove the ineffective nodes near the design domain 30. Otherwise, the method goes to Step 463 to record the positions of un-removed ineffective nodes if the there is not any cavity in the design domain. Then in Step 464, an ineffective node with a smallest stress is searched among the un-removed ineffective nodes. In Step 465, an ineffective domain having the ineffective node with a smallest stress as a center is created. The ineffective domain is arbitrarily shaped, for example, round, polygonal or irregular closed. In the present embodiment, the ineffective domain is round.

It is preferable that the size of the ineffective domain is determined according to actual needs. Preferably, the ineffective domain is smaller than a domain having ineffective nodes gathering, as shown in FIG. 9A, wherein there are a plurality of ineffective nodes 316 gathering around the ineffective nodes 316. Then, in Step 466, the nodes in the ineffective domain are removed to create a cavity. In FIG. 9A, if the ineffective nodes 318 are the minimum stress nodes in the design domain and the ineffective nodes 318 are used as a center of a circle containing a plurality of ineffective nodes, an ineffective domain will be created after the plurality of ineffective nodes in the circle are all removed, as shown in FIG. 9B.

Returning to FIG. 8A, in Step 467, ineffective nodes on the boundaries of neighboring cavities are removed so as to prevent the formation of cavities in Step 465 that leads to discontinuity of the design domain because the ineffective nodes are close to the cavity boundaries to form incomplete cavities. Step 467 comprises three steps as shown in FIG. 8C, which is a flow-chart of a step of removing an ineffective node in an ineffective domain according to a second embodiment of the present invention. In Step 4670, the boundary of the ineffective domain is shifted a second specific displacement outwards. In Step 4671, a distance from each ineffective node of the ineffective nodes in the design domain to the boundary of the ineffective domain is measured. Then in Step 4672, the ineffective node is removed if the distance is smaller than the second specific displacement.

With reference to FIG. 9B, wherein the boundary 3150 of the ineffective domain 315 is shifted a second specific displacement 95 outwards, the ineffective node 319 is removed because the distance from the ineffective node 319 to the boundary 3150 of the ineffective domain 3150 is smaller than the second specific displacement. On the contrary, in FIG. 9B, the nodes 316 do not need to be removed because the distance between the nodes 316 and the boundary 3150 is larger than the second specific displacement 95. Returning to FIG. 8A, in Step 468, it is determined whether there are other ineffective nodes. If the there are other ineffective nodes, Step 464 to Step 468 are repeated. Otherwise, the method goes to Step 46 in FIG. 7. Step 462 in FIG. 8 is similar to Step 467, and thus the description thereof is not repeated here.

Please refer to FIG. 8D, which is a flow-chart of an alternative step of forming a cavity according to a second embodiment of the present invention. With reference to FIG. 8D, Step 468a is to determine whether the number of the cavities reaches a required number to control the topology resolutions. Concerning the material preparation and actual requirement, not all the cavities are required. The structure designer can design a structure using topology resolutions to reduce engineering complex and speed up computational efficiency.

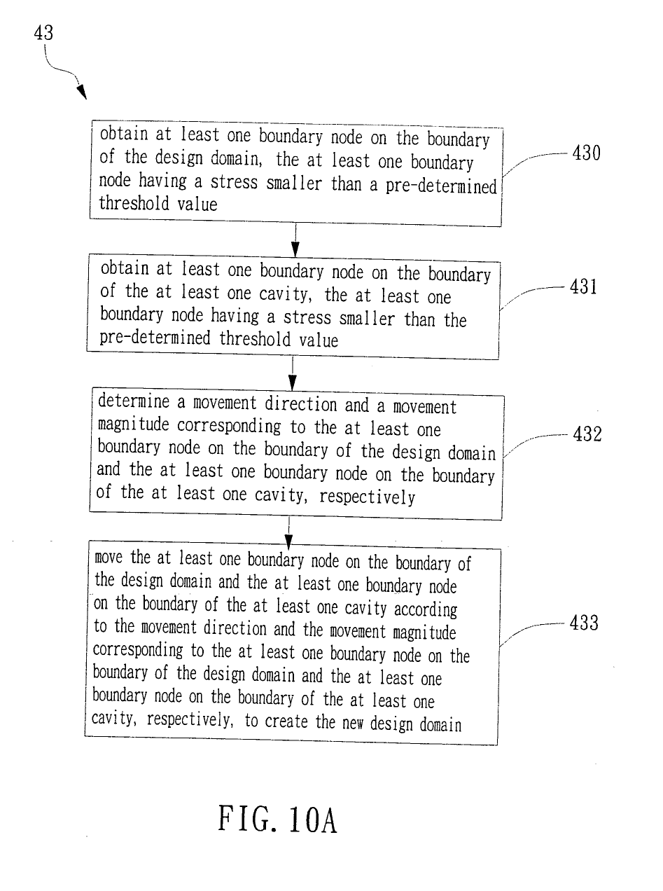

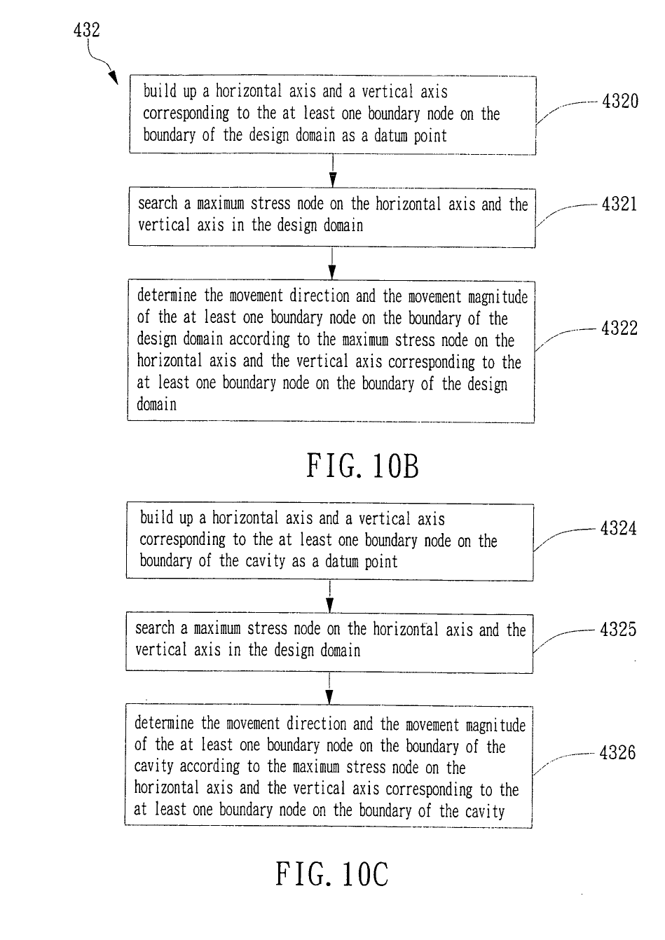

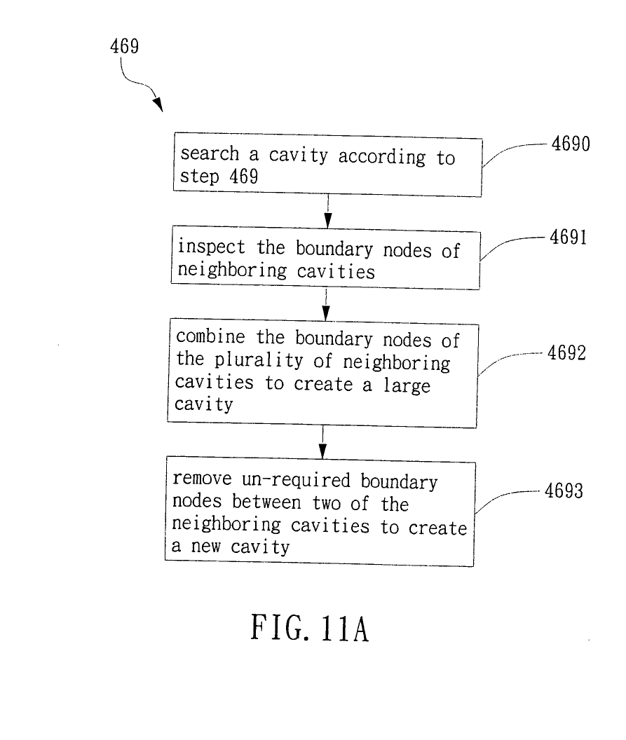

Returning to FIG. 7, in Step 47, finite element analysis is performed. In Step 48, it is determined whether the pre-determined threshold is reached. Step 48 is performed to determine whether the minimum stress node on the design domain boundary has a stress smaller than the pre-determined threshold ORσ_{N}^{VM max}. If the stress is not smaller than the pre-determined threshold, the method goes back to Step 43 to move at least one node on the boundary of the design domain and move at least one node on the boundary of the cavity. In FIG. 10A, which is a flow-chart of a step of moving a boundary node according to a second embodiment of the present invention. After finite element analysis is performed in Step 47, in Step 430, at least one boundary node having a stress smaller than a pre-determined threshold value ORσ_{N}^{VM max} is obtained on the boundary of the design domain. In Step 431, at least one boundary node having a stress smaller than the pre-determined threshold value ORσ_{N}^{VM max} is obtained on the boundary of the at least one cavity. In Step 432, the movement direction and the movement magnitude are determined. Then in Step 433, the at least one boundary node on the boundary of the design domain and the at least one boundary node on the boundary of the at least one cavity are moved according to the movement direction and the movement magnitude corresponding to the at least one boundary node on the boundary of the design domain and the at least one boundary node on the boundary of the at least one cavity, respectively, to create the new design domain. The movement direction and the movement magnitude can be expressed by equations (1) and (2).

FIG. 10B and FIG. 10C show a flow-chart of a step of determining the movement direction and the movement magnitude in Step 432. More particularly, FIG. 10B shows a flow-chart of a step of determining the movement direction and the movement magnitude of a boundary node on the design domain boundary, and FIG. 10C shows a flow-chart of a step of determining the movement direction and the movement magnitude of a boundary node on the cavity boundary. With reference to FIG. 10B, in Step 4320, a horizontal axis and a vertical axis are built up corresponding to the at least one boundary node on the boundary of the design domain as a datum point. Then in Step 4321, a maximum stress node on the horizontal axis and the vertical axis is searched in the design domain. In Step 4322, the movement direction and the movement magnitude of the at least one boundary node on the boundary of the design domain are determined. The movement direction and the movement magnitude can be expressed by equations (1) and (2). The way of determining is similar to that in the first embodiment, and therefore the description thereof is not repeated here. The step of determining in FIG. 10C is similar to that in FIG. 10B, and therefore the description thereof is not repeated here.

Retuning to FIG. 7, Step 46 to Step 48 are repeated until the pre-determined threshold is reached. Meanwhile, a plurality of cavities are created after repeating Step 46 to Step 48. The strength of the regions between cavities to resist the stress is variable. Generally, in high topology resolution optimization, the regions between cavities become thinner and weaker to resist the stress when the number of calculation increases. Therefore, Step 469 is performed to combine two neighboring cavities into a larger cavity to enhance calculation efficiency. In Step 469, neighboring cavities are combined as one when the spacing between neighboring cavities is smaller than a threshold.

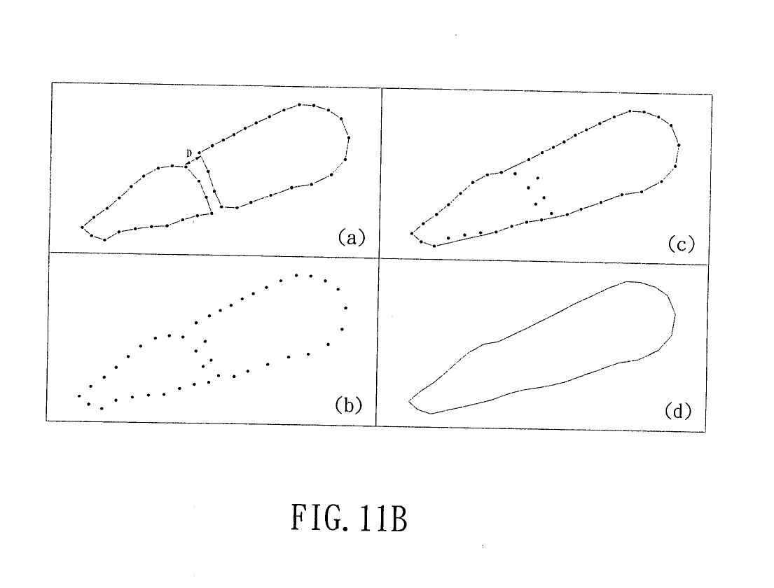

Please refer to FIG. 11A, which is a flow-chart of a step of combining two cavities. In Step 4690, a cavity is searched according to Step 469, wherein the spacing D between neighboring cavities is smaller than a threshold, as shown in FIG. 11B(a). In Step 4691, the boundary nodes of neighboring cavities are inspected, as shown in FIG. 11B(b). In Step 4692, the boundary nodes of the plurality of neighboring cavities are combined to create a large cavity, as shown in FIG. 11B(c). Finally, in Step 4693, un-required boundary nodes (FIG. 11B(d)) between two of the neighboring cavities are removed to create a new cavity. When the pre-determined threshold is reached (in Step 48), the optimum ratio is set to zero in Step 49, and then the method returns to Step 42. Then the method returns to Step 41 until Step 4a to stop operation to achieve an optimized structure.

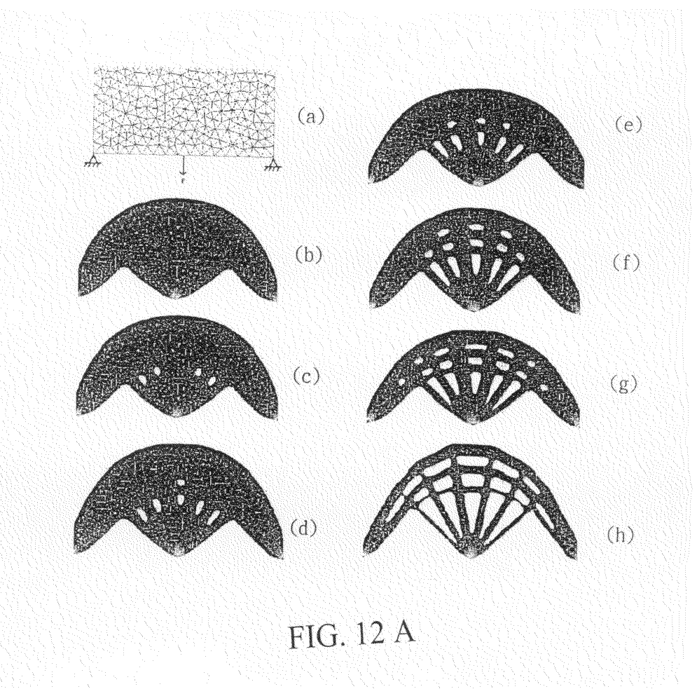

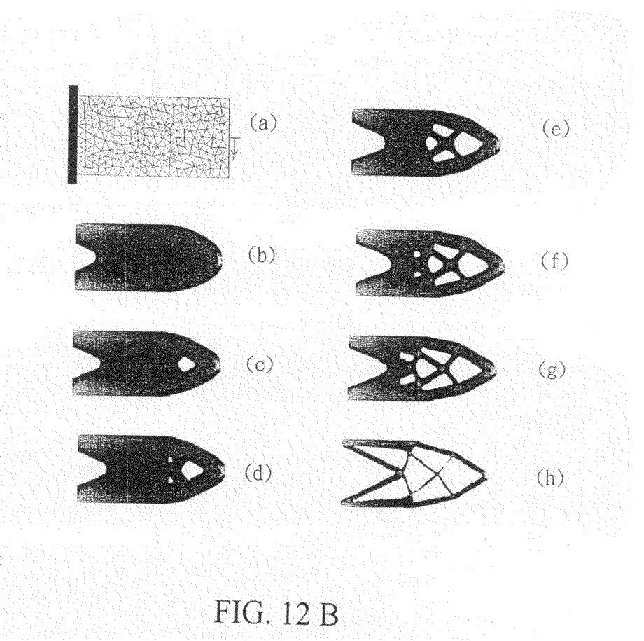

For a better understanding of the steps in FIG. 7, two embodiments are exemplified in the present invention. Please refer to FIG. 7 and FIG. 12A. FIG. 12A shows schematic diagrams of a solution to the Michell's Arc problem using a method of evolutionary optimization algorithm for structure design according to a second embodiment of the present invention. FIG. 12A(a) shows the result described in Step 40. The design domain can be rectangular, or the like. The meshes in FIG. 12A(a) are for infinite element analysis. The meshes are generated using conventional techniques and thus the description thereof is not repeated here.

In the beginning, there is no cavity in the design domain. Therefore, in Step 43, only the boundary nodes on the design domain boundary are moved and only the shape of the design domain is changed, which can be corresponded to FIG. 12A(b). The optimization is only for the shape of the design domain as a result of the first embodiment of the present invention.

In Step 45 and Step 46, there is a cavity in the design domain, as shown in FIG. 12A(c). Only the boundary nodes on the design domain boundary are moved. When there are cavities in the design domain, the optimization process using the topology algorithm begins.

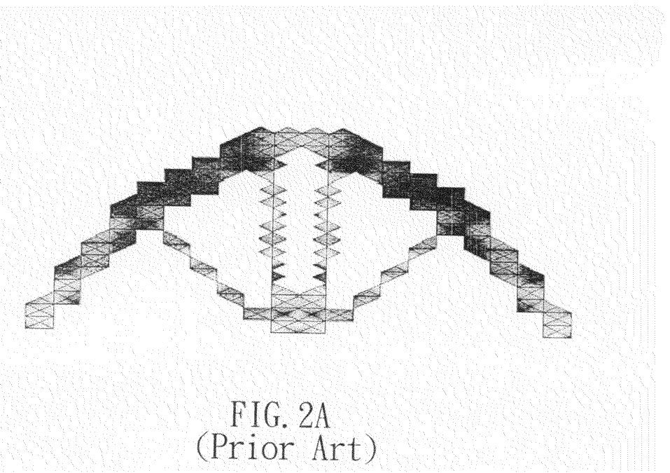

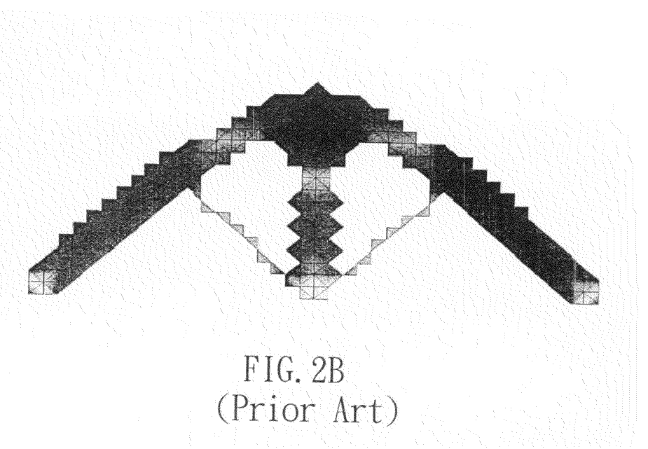

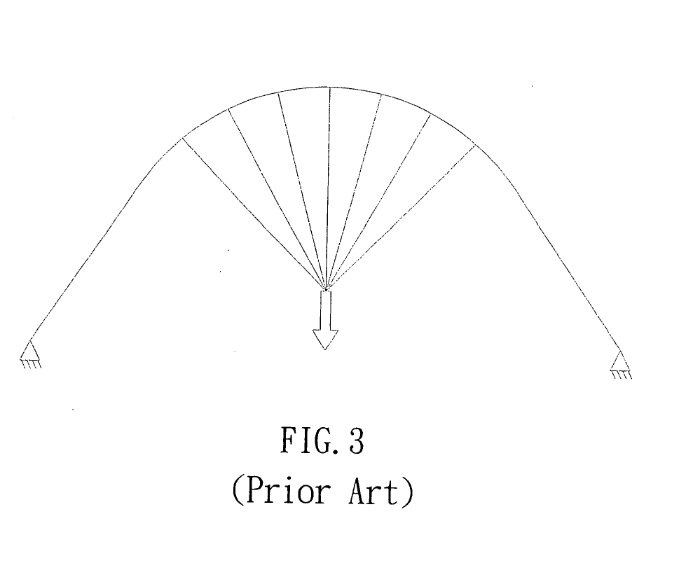

During iteration between Step 40 to Step 49, the design domain and cavities are re-shaped and the number of cavities increases, as shown in FIG. 12A(d) to FIG. 12A(g). Iteration stops at Step 4a. The rectangular design domain is re-shaped as shown in FIG. 12A(h) to achieve structure optimization. In Step 45 and Step 46 for creating cavities, un-required material can be removed so as to reduce manufacturing cost. Comparing FIG. 12A(h) to FIG. 2A and FIG. 2B, it is found that the mesh-dependency and stair-case effect issues in conventional technology have been overcome by using the method disclosed in the present invention. The result shown in FIG. 12A(h) is very similar to the theoretical solution shown in FIG. 3. Please refer to FIG. 12B, which shows schematic diagrams of a solution to a cantilever truss problem using a method of evolutionary optimization algorithm for structure design according to a second embodiment of the present invention. More particularly, in the present invention, the boundary node is moved to the node with higher stress, which indicates that the materials with larger strength to resist higher stress are reserved while the materials with smaller strength are removed. Therefore, structure optimization can be achieved by iteratively moving the nodes to remove low stress-resistance material while reserving high stress-resistance material.

The present invention is characterized in that each calculation is non-black box and traceable and each evolution results in a new design. For example, 100 new designs will appear after 100 evolutions. Even though these 100 new designs is quite similar, 100 new designs result in new products as long as they are different in some way. Therefore, the present invention makes structure design easy and less costly.

According to the above discussion, it is apparent that the present invention discloses a method of evolutionary optimization algorithm for structure design using a polygon to describe a geometric structure and performing finite element analysis to move the evolutionary nodes to optimize the structure and achieve structural optimization. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method of evolutionary optimization algorithm for structure design, comprising steps of:
(a) creating a design domain with at least one boundary condition;
(b) meshing the design domain for performing finite element analysis (FEA) to determine a stress distribution corresponding to the design domain;
(c) moving at least one node on the boundary of the design domain according to the stress distribution to create a new design domain; and
(d) repeating from step (b) to step (d) according to the new design domain as a result of step (c) to create a structure.

2. The method of evolutionary optimization algorithm for structure design as recited in claim 1, wherein step (c) further comprises steps of:
(c1) obtaining at least one boundary node from the at least one node on the boundary of the design domain, the at least one boundary node having a stress smaller than a pre-determined threshold value;
(c2) determining a movement direction and a movement magnitude corresponding to the at least one boundary node; and
(c3) moving the at least one boundary node according to the movement direction and the movement magnitude corresponding to the at least one boundary node to create the new design domain.

3. The method of evolutionary optimization algorithm for structure design as recited in claim 2, wherein step (c2) further comprises steps of:
(c21) building up two datum axes corresponding to the at least one boundary node as a datum point;
(c22) searching a maximum stress node on the two datum axes in the design domain; and
(c23) determining the movement direction and the movement magnitude of the at least one boundary node according to the maximum stress node on the two datum axes corresponding to the at least one boundary node.

4. The method of evolutionary optimization algorithm for structure design as recited in claim 3, wherein the angle between the two datum axes is larger than zero degree and smaller than 90 degrees.

5. The method of evolutionary optimization algorithm for structure design as recited in claim 3, wherein the movement direction and the movement magnitude are functions of a relative distance indicating a distance from the boundary node to the maximum stress node and a relative stress indicating a ratio of the stress on the boundary node to the stress on the maximum stress node.

6. The method of evolutionary optimization algorithm for structure design as recited in claim 1, wherein the design domain is one of a planar domain, a rectangular domain and an initially shaped structure.

7. The method of evolutionary optimization algorithm for structure design as recited in claim 2, wherein the pre-determined threshold value is a product of a Maximum Von Mises stress in the design domain using FEA in step (b) and a specific value.

8. A method of evolutionary optimization algorithm for structure design, comprising steps of:
(a) creating a design domain with at least one boundary condition;
(b) meshing the design domain for performing finite element analysis (FEA) to determine a stress distribution corresponding to the design domain;
(c) creating at least one cavity in the design domain;
(d) moving at least one node on the boundary of the design domain and at least one node on the boundary of the cavity according to the stress distribution to create a new design domain; and
(e) repeating from step (b) to step (e) according to the new design domain as a result of step (d) to create a structure.

9. The method of evolutionary optimization algorithm for structure design as recited in claim 8, wherein the design domain is one of a planar domain, a rectangular domain and an initially shaped structure.

10. The method of evolutionary optimization algorithm for structure design as recited in claim 8, wherein step (d) further comprises steps of:
(d1) obtaining at least one boundary node on the boundary of the design domain, the at least one boundary node having a stress smaller than a pre-determined threshold value;
(d2) obtaining at least one boundary node on the boundary of the at least one cavity, the at least one boundary node having a stress smaller than the pre-determined threshold value;
(d3) determining a movement direction and a movement magnitude corresponding to the at least one boundary node on the boundary of the design domain and the at least one boundary node on the boundary of the at least one cavity, respectively; and
(d4) moving the at least one boundary node on the boundary of the design domain and the at least one boundary node on the boundary of the at least one cavity according to the movement direction and the movement magnitude corresponding to the at least one boundary node on the boundary of the design domain and the at least one boundary node on the boundary of the at least one cavity, respectively, to create the new design domain.

11. The method of evolutionary optimization algorithm for structure design as recited in claim 10, wherein step (d3) further comprises steps of:
(d31a) building up two datum axes corresponding to the at least one boundary node on the boundary of the design domain as a datum point;
(d32a) searching a maximum stress node on the two datum axes in the design domain; and
(d33a) determining the movement direction and the movement magnitude of the at least one boundary node on the boundary of the design domain according to the maximum stress node on the two datum axes corresponding to the at least one boundary node on the boundary of the design domain.

12. The method of evolutionary optimization algorithm for structure design as recited in claim 11, wherein the angle between the two datum axes is larger than zero degree and smaller than 90 degrees.

13. The method of evolutionary optimization algorithm for structure design as recited in claim 11, wherein the movement direction and the movement magnitude are functions of a relative distance indicating a distance from the boundary node to the maximum stress node and a relative stress indicating a ratio of the stress on the boundary node to the stress on the maximum stress node.

14. The method of evolutionary optimization algorithm for structure design as recited in claim 8, wherein step (d3) further comprises steps of:
(d31b) building up two datum axes corresponding to the at least one boundary node on the boundary of the cavity as a datum point;
(d32b) searching a maximum stress node on the two datum axes in the design domain; and
(d33b) determining the movement direction and the movement magnitude of the at least one boundary node on the boundary of the cavity according to the maximum stress node on the two datum axes corresponding to the at least one boundary node on the boundary of the cavity.

15. The method of evolutionary optimization algorithm for structure design as recited in claim 14, wherein the angle between the two datum axes is larger than zero degree and smaller than 90 degrees.

16. The method of evolutionary optimization algorithm for structure design as recited in claim 14, wherein the movement direction and the movement magnitude are functions of a relative distance indicating a distance from the boundary node to the maximum stress node and a relative stress indicating a ratio of the stress on the boundary node to the stress on the maximum stress node.

17. The method of evolutionary optimization algorithm for structure design as recited in claim 10, wherein the predetermined threshold value is a product of a Maximum Von Mises stress in the design domain using FEA and a specific value.

18. The method of evolutionary optimization algorithm for structure design as recited in claim 8, wherein step (c) further comprises steps of:
(c1) obtaining a plurality of ineffective nodes in the design domain, the plurality of ineffective nodes having a stress smaller than a smallest stress on the boundary of the design domain;
(c2) obtaining an ineffective node from the plurality of ineffective nodes, the ineffective node having a smallest stress;
(c3) creating an ineffective domain using the ineffective node having the smallest stress as a center of the ineffective domain;
(c4) removing any node in the ineffective domain; and
(c5) repeating from step (c2) to step (c5) to create the at least one cavity in the design domain.

19. The method of evolutionary optimization algorithm for structure design as recited in claim 8, wherein step (c) further comprises steps of:
(c1) obtaining a plurality of ineffective nodes in the design domain, the plurality of ineffective nodes having a stress smaller than a smallest stress on the boundary of the design domain;
(c2) removing any un-required ineffective node;
(c3) obtaining an ineffective node from a plurality of un-removed ineffective nodes, the ineffective node having a smallest stress;
(c4) creating an ineffective domain using the ineffective node having the smallest stress as a center of the ineffective domain;
(c5) removing any node in the ineffective domain; and
(c6) repeating from step (c3) to step (c6) to create the at least one cavity in the design domain.

20. The method of evolutionary optimization algorithm for structure design as recited in claim 19, wherein step (c2) further comprises steps of:
(c20) shifting the boundary of the design domain a first specific displacement inwards;
(c21) determining whether the ineffective nodes in the design domain are to be removed according to the first specific displacement;
(c22) determining whether there is at least one cavity in the design domain;
(c23) shifting the boundary of the at least one cavity a second specific displacement outwards if there is at least one cavity in the design domain; and
(c24) determining whether the ineffective nodes in the cavity are to be removed according to the second specific displacement

21. The method of evolutionary optimization algorithm for structure design as recited in claim 20, wherein step (c21) further comprises steps of:
(c210) measuring a distance from each ineffective node of the ineffective nodes in the design domain to the boundary of the design domain; and
(c211) determining whether the distance is smaller than the first specific displacement and removing the ineffective node if the distance is smaller than the first specific displacement.

22. The method of evolutionary optimization algorithm for structure design as recited in claim 20, wherein step (c24) further comprises steps of:
(c240) measuring a distance from each ineffective node of the ineffective nodes in the cavity to the boundary of the cavity; and
(c241) determining whether the distance is smaller than the second specific displacement and removing the ineffective node if the distance is smaller than the second specific displacement.

23. The method of evolutionary optimization algorithm for structure design as recited in claim 8, further comprising a step of combining a plurality of neighboring cavities as one if the boundaries of the plurality of neighboring cavities are separated by a spacing smaller than a predetermined spacing.

24. The method of evolutionary optimization algorithm for structure design as recited in claim 8, wherein step (c) further comprises a step of determining the number of the cavities to control the topology resolutions.
